(19) United States
(12) Patent Application Publication
(10) Pub. No.: US 2025/0149923 A1
(43) Pub. Date: May 8, 2025

(54) WIRELESS POWER RECEIVER ARRANGEMENT WITH PLANAR INDUCTOR ARRANGEMENT AND RECONFIGURABLE SWITCHING NETWORK

(71) Applicant: Huawei Digital Power Technologies Co., Ltd., Shenzhen (CN)

(72) Inventors: Fralett SUAREZ SANDOVAL, Munich (DE); Sarai Malinal TORRES DELGADO, Munich (DE)

(73) Assignee: Huawei Digital Power Technologies Co., Ltd., Shenzhen (CN)

(21) Appl. No.: 18/949,939

(22) Filed: Nov. 15, 2024

Related U.S. Application Data
(63) Continuation of application No. PCT/EP2022/063344, filed on May 17, 2022.

(51) Int. Cl. H02J 50/12

(52) U.S. Cl. CPC H02J 50/12

(57) ABSTRACT

The disclosure relates to wireless a power receiver arrangement including a load, a planar inductor arrangement comprising a plurality of coil segments, and a reconfigurable switching network electrically coupled between coil segments of the plurality of coil segments. The coil segments span across respective areas of a plurality of areas and the load. The reconfigurable switching network includes a plurality of switches configured to interconnect at least a coil segment from the plurality of coil segments which spans across a smallest area of the plurality of areas according to a switching configuration to obtain a closed electrical circuit for powering the load with electrical energy from the electromagnetic field. The arrangement further includes a controller configured to determine the switching configuration in order to reduce a variation of an electromagnetic coupling of the planar inductor arrangement to the wireless power transmitter.

### CROSS-REFERENCE TO RELATED APPLICATIONS

This application is a continuation of International Application No. PCT/EP2022/063344, filed on May 17, 2022, the disclosure of which is hereby incorporated by reference in its entirety.

### TECHNICAL FIELD

The disclosure relates to the field of wireless power transfer. In particular, the disclosure relates to a wireless power receiver arrangement comprising a planar inductor arrangement and a reconfigurable switching network and corresponding wireless power transfer systems. The disclosure further relates to a method for controlling such wireless power receiver arrangement.

### BACKGROUND

In currently available wireless power transfer systems to recharge battery-powered devices, the mayor engineering challenge is the reduced positioning freedom of the target device(s). Making this type of technology highly sensitive to lateral or angular misalignments between the transmitter and receiver devices causes the problem that the receiver device is not properly charged or even not charged at all in some locations, and in the worst case, the receiver device can actually be damaged when placed in a zone that presents him with a high coupling factor to the transmitter.

### SUMMARY

This disclosure provides a solution for wireless power transmission in which the wireless power transmitter device is capable of supporting several receiver devices simultaneously regardless of their relative location in space and their specific power demands which can be different according to the charging status of the battery.

In particular, the disclosure presents a solution for wireless power transfer systems subjected to a very large coupling-factor variation as in systems in which the transmitter is meant to provide simultaneous wireless power to receivers located close (contact) and far from the transmitter. This is in general a challenge because the transmitter device has to ensure to work at a current level high enough to provide usable power to receivers located far away while at the same time not damage receivers located very close to it.

A basic concept of the disclosure is to use an incremental geometry for the inductive element of the resonant circuit of a wireless power receiver whose number of turns and consequently the inductance is selectively changed by means of a switching network according to the received power from the transmitter.

For the disclosed wireless power receiver arrangements and devices, efficient wireless power transmission is ensured at any operating state since the switching configurations permit to maintain a similar resonance frequency as the operating frequency of the transmitter device. Moreover, the concept presented in this disclosure allows the use of a power amplifier on the transmitter side operating as a constant current source which facilitates the simultaneous power delivery to several receiver devices. The use of a current source on the transmitter side is desirable as its power consumption when no receiver devices are present, i.e., during the unloaded operation, is low. The unloaded power consumption depends on the resistive characteristics of the transmitter resonator and the associated circuitry.

For the disclosed wireless power receiver arrangements and devices, changing the inductance permits to change the effective coupling factor to the transmitter resonator, thereby avoiding exceeding the maximum ratings of the components in the receiver device when it is too close to the transmitter while allowing operational output powers to be obtained when the receiver device is far away. This allows for the one-to-many WPT system to function independently from the individual receiver's coupling and condition.

In order to describe the disclosure in detail, the following terms and notations will be used.
WPT wireless power transfer
PCB printed circuit board
DC direct current
AC alternating current
AC-DC alternating current to direct current converter converter
DC-DC direct current to direct current converter converter

In this disclosure, wireless power transfer (WPT) systems are described, in particular one-to-one WPT systems, one-to-many WPT systems, many-to-one WPT systems and many-to-many WPT systems.

One-to-one WPT systems are wireless power transfer systems composed by a single transmitter and a single receiver device. One-to-many WPT systems are wireless power transfer systems composed by a single transmitter and multiple receiver devices. Many-to-one WPT systems are wireless power transfer systems composed by multiple transmitter and a single receiver device. Many-to-many WPT systems are wireless power transfer systems composed by multiple transmitter and multiple receiver devices.

Wireless power transfer is the transmission of electrical energy without the use of wires as a physical link. This technology uses a transmitter device capable of generating a time-varying electromagnetic field that causes a circulating electric field through a receiver device (or devices) based on the principle of electromagnetic induction. The receiver device (or devices) is (are) capable of being supplied directly from this circulating electric field or they convert it to a suitable power level to supply to an electrical load or battery connected to them. In the following, wireless power transmission systems are described.

Nowadays the number of battery-powered electronic devices is increasing rapidly because they provide freedom of movement and portability. These devices should be continuously recharged to ensure they function. Their charging frequency could be diminished by the use of a large battery, but these impact the overall cost of the electronic device, as well as their weight and size.

Charging of battery-powered electronic devices is usually done with the use of a wall charger and a dedicated cable that connects to an input port of the device to be charged to establish an electrical connection between the power supply and the power-hungry device. Some disadvantages of this charging mechanism are summarized as: a) The connector at this input port is susceptible to mechanical failure due to the connection/disconnection cycles required to charge the battery; b) Each battery-powered device comes with its dedicated cable and wall charger. These two components function sometimes exclusively with each device and are not interchangeable between devices. This increases the cost of the device and the electronic-waste generated by the non-functional wall chargers and cables; c) The production of waterproof devices becomes more challenging due to the higher cost associated with the enclosure required around the input port of the battery-powered electronic device; and d) The use of a cable restricts the mobility of the user according to the length of the charging cable.

In order to avoid these disadvantages, several methods for wireless power transmission (WPT) to recharge the battery of the electronic device without the use of a charging cable have been proposed in recent history.

Commercial wireless power transfer systems have mainly been driven by two organizations, the Wireless Power Consortium and the AirFuel Alliance. The Wireless Power Consortium created the Qi Standard to wirelessly charge consumer electronic devices using magnetic induction from a base station, usually a thin mat-like object, containing one or more transmitter inductors and a target device fitted with a receiving inductor. Qi systems require close proximity of the transmitter and receiver devices, usually within a couple of millimeters to a couple of centimeters.

Wireless power transfer systems that function under the AirFuel Alliance principle use a resonant inductive coupling between the transmitter inductor and the receiver inductor to consequently charge the battery connected to the receiver device. The resonant coupling allows for the power to be transferred over greater distances. The overall system efficiency is a function of the resonators' quality factor and the coupling factor between their inductive elements.

According to a first aspect, the disclosure relates to a wireless power receiver arrangement for receiving an electromagnetic field from a wireless power transmitter, the wireless power receiver arrangement comprising: a load; a planar inductor arrangement comprising a plurality of coil segments each coil segment spanning across a respective area of a plurality of areas; wherein the respective areas are arranged inside each other; a reconfigurable switching network electrically coupled between coil segments of the plurality of coil segments, the coil segments spanning across the respective areas of the plurality of areas, and the load, the reconfigurable switching network comprising a plurality of switches, the plurality of switches being configured to interconnect at least a coil segment from the plurality of coil segments which is spanning across a smallest area of the plurality of areas according to a switching configuration to obtain a closed electrical circuit for powering the load with electrical energy from the electromagnetic field; and a control unit configured to determine the switching configuration in order to reduce a variation of an electromagnetic coupling of the planar inductor arrangement to the wireless power transmitter.

Such a wireless power receiver arrangement provides an advantageous solution for wireless power transfer subjected to a very large coupling-factor variation, in particular for systems in which the transmitter provides simultaneous wireless power to receivers located close (e.g., in contact) or far from the transmitter. By controlling the switching configuration of the switching network, the receiver arrangement can adapt to the above situations and can ensure operation at all possible distances from the transmitter, i.e., when located far away or when located close or very close to the transmitter without being damaged.

The inductor arrangement is referred herein as a planar inductor arrangement. This term also comprises a flat inductor arrangement and a substantially planar inductor arrangement. It means that the term planar inductor arrangement also includes an inductor arrangement in which the coil segments are placed in different layers of a printed circuit board as described below. The PCB per se is a planar arrangement. Note that the respective areas across which the coil segments are spanned, are consecutive areas. These areas are arranged inside each other as defined above.

In an exemplary implementation of the wireless power receiver arrangement, the control unit is configured to determine a mutual inductance of the inductor arrangement to the wireless power transmitter and to set the switching configuration in order to reduce a variation of the mutual inductance.

This provides the advantage that the wireless power receiver arrangement can efficiently adapt to changing coupling environments by accordingly setting the switching configuration.

In an exemplary implementation of the wireless power receiver arrangement, the respective areas of the plurality of areas are formed by conductive layers of a multi-layer printed circuit board.

This provides the advantage that the wireless power receiver arrangement can be easily manufactured with standard fabrication methods.

In this case, the term “areas arranged inside each other” refers to projections of the areas of the different layers onto a common reference layer of the PCB, e.g., a top layer or a bottom layer of the PCB or simply the main PCB plane.

In an exemplary implementation of the wireless power receiver arrangement, the coil segments of the plurality of coil segments are placed in different layers of the multi-layer printed circuit board.

This provides the advantage that the coil segments can overlap in the X- or Y-direction due to a differing layer height in the z-direction, i.e., in the direction perpendicular to the PCB plane. This allows forming a large variety of different coil geometries.

In an exemplary implementation of the wireless power receiver arrangement, the spanning areas of each coil segment are partially overlapping.

This provides the advantage that a lot of different coil geometries can be formed in order to optimally adapt to the respective location scenario and distance to the transmitter.

In an exemplary implementation of the wireless power receiver arrangement, the flat inductor arrangement forms a receiver inductor whose physical length can be incremented or decremented to account for mutual inductance variations to the wireless power transmitter while allowing the wireless power transmitter to have a constant current level.

This provides the advantage that the transmitter configuration can stay unchanged while only a change in the receiver configuration, i.e., the switching configuration of the receiver coil segments, is sufficient to account for such mutual inductance variations.

In an exemplary implementation of the wireless power receiver arrangement, the plurality of switches is configured to connect the coil segments from the plurality of coil segments to at least one capacitor to create a resonant electrical circuit.

This provides the advantage that depending on the respective capacitors different resonant electrical circuits can be provided to improve the efficiency of the wireless power transmission by the resonant operation.

In an exemplary implementation of the wireless power receiver arrangement, the resonant electrical circuit is created by the plurality of switches to have the same resonance frequency as an operating frequency of the wireless power transmitter; or the resonance frequency of the resonant electrical circuit lies within a threshold range around the operating frequency of the wireless power transmitter.

This provides the advantage that the same resonance frequency or at least a frequency close to that transmitter frequency improves operation and efficiency of the wireless power receiver arrangement.

In an exemplary implementation of the wireless power receiver arrangement, each coil segment of the plurality of coil segments comprises an integer number of turns.

This provides the advantage that a step-wise increase in inductivity can be achieved with increments of inductivity. Note that the increase in inductance is not linear for every turn that is added.

In an exemplary implementation of the wireless power receiver arrangement, each coil segment of the plurality of coil segments has one of the following shapes: a circular shape, an oval shape, a meander shape, or any other polygonal shape.

This provides the advantage that the coils can be flexible designed in order to provide high coupling efficiency.

The plurality of switches may comprise one or more of transistors, solid-state relays or mechanical switches automatically actuated according to the switching configuration. The wireless power receiver arrangement may comprise an AC-DC converter configured to convert the electrical energy from the electromagnetic field into a direct current for powering a load that requires DC current.

The wireless power receiver arrangement may comprise at least one of: a DC-DC converter configured to convert a DC power level provided by the AC-DC converter into another DC power level; or a charging circuit configured to regulate the DC power provided by the AC-DC converter to ensure a certain voltage level at an input of the load.

According to a second aspect, the disclosure relates to a wireless power transfer system, comprising: a wireless power transmitter for generating an electromagnetic field from a constant current source; and at least one wireless power receiver arrangement according to the first aspect described above for receiving the electromagnetic field from the wireless power transmitter for powering the load with electrical energy from the electromagnetic field.

In such a wireless power transfer system the wireless power transmitter is capable of supporting several receiver devices simultaneously regardless of their relative location in space and their specific power demands which can be different according to the charging status of the battery.

In an exemplary implementation of the wireless power transfer system, an inductance of the flat inductor arrangement is smaller for a wireless power receiver arrangement located closer to the wireless power transmitter than for a wireless power receiver arrangement located less close to the wireless power transmitter.

This provides the advantage that the wireless power transfer system can efficiently adapt to varying environments and varying distances between transmitter and receiver.

According to a third aspect, the disclosure relates to a method for controlling a wireless power receiver arrangement for receiving an electromagnetic field from a wireless power transmitter, wherein the wireless power receiver arrangement comprises: a load; a planar inductor arrangement comprising a plurality of coil segments each coil segment spanning across a respective area of a plurality of areas; wherein the respective areas are arranged inside each other; and a reconfigurable switching network electrically coupled between coil segments of the plurality of coil segments, the coil segments spanning across the respective areas of the plurality of areas and the load, the reconfigurable switching network comprising a plurality of switches, the plurality of switches being configured to interconnect at least a coil segment from the plurality of coil segments which is spanning across a smallest area of the plurality of areas according to a switching configuration to obtain a closed electrical circuit for powering the load with electrical energy from the electromagnetic field, the method comprising: determining an electromagnetic coupling of the planar inductor arrangement to the wireless power transmitter; and setting the switching configuration based on the electromagnetic coupling.

Such a method provides an advantageous solution for wireless power transfer subjected to very large coupling-factor variations, in particular for systems in which the transmitter provides simultaneous wireless power to receivers located close (e.g., in contact) or far from the transmitter. By controlling the switching configuration of the switching network, the method can adapt to the above situations and can ensure operation at all possible distances between receiver and transmitter, i.e., for one or multiple receivers located far away or close to the transmitter.

In an exemplary implementation of the method, the respective areas of the plurality of areas comprise conductive layers of a multi-layer printed circuit board.

This provides the advantage that the wireless power receiver arrangement which is controlled by this method can be easily manufactured with standard fabrication methods.

In an exemplary implementation of the method, the method comprises: connecting the coil segments by the plurality of switches to at least one capacitor to create a resonant electrical circuit, wherein a resonance frequency of the resonant electrical circuit corresponds to an operating frequency of the wireless power transmitter.

This provides the advantage that depending on the respective capacitors different resonant electrical circuits can be provided and controlled by this method to adapt to different transmitter operating frequencies, thereby improving performance of the wireless power transmission.

Using the same resonance frequency or at least a frequency close to that of the transmitter operating frequency improves operation and efficiency of the wireless power transfer.

In the following, advantages and advantageous effects are described which can be achieved by the devices, methods, systems and arrangements described in this disclosure.

Due to the switching network and the different switching configurations, the receiver coils can have variable size and geometry. This provides the advantageous effects that the mutual inductance to the transmitter coil can be changed. The feasibility to change the mutual inductance to the transmitter coil allows to limit the received power to a desired and safe level when located too close to the transmitter. This further allows to use smaller rated components on the receiver modules instead of using largely rated components when having a non-variable in size receiver coil that gets too close to the transmitter device.

The feasibility to change the mutual inductance to the transmitter coil allows to increment the mutual inductance which allows transferring wireless power at an increased distance more efficiently. It further allows changing the reflected impedance to the transmitter device from one value to another. This capability can boost the efficiency of the WPT link and/or limit the output power.

The planarity of the inductor arrangement allows implementation of such receiver coils in substantially planar receiver devices like smartphones or smartwatches.

The control unit can sense when the receiver is receiving too much power (it is highly coupled to the transmitter). This control allows the switching network to be operated and the coil segments to be correspondingly changed, thereby avoiding damage to the receiver. The control unit can ensure that enough coil segments are connected such that the receiver has usable and acceptable power level when the receiver is far away from the transmitter.

The switching network allows to selectively connect the most suited combination of coil segments according to the information received by the control unit and achieve a beneficial change in the mutual inductance between the receiver and the transmitter.

The switching network allows to connect to different capacitors in such a way that the same resonance frequency is maintained regardless of the combination of coil segments and capacitors being connected to the receiver modules. A resonance frequency equal for the receiver device(s) and the transmitter is desirable because it enhances the efficiency of the wireless power link.

The wireless power receiver arrangement allows coupling to a transmitter device that uses a single transmitter coil and a single power amplifier. Such a minimalistic configuration decreases the complexity and enhances the overall efficiency of the WPT system.

The applicability of such a device is independent of the transmitter's working principle as well as the set excitation level of the transmitter, meaning that it allows for interoperability to transmitters with different output power characteristics as long as the resonance frequencies of the transmitter and receiver resonators are close with respect to each other.

The wireless power receiver arrangement is independent of its manufacturing method; therefore, many coil manufacturing methods can be used.

### BRIEF DESCRIPTION OF THE DRAWINGS

Further embodiments of the disclosure will be described with respect to the following figures, in which:

FIG. 1 shows a schematic diagram of a wireless power receiver arrangement 100 according to the disclosure;

FIGS. 2a, 2b, 2c show schematic diagrams illustrating exemplary coil segments of the wireless power receiver arrangement 100;

FIGS. 3a, 3b show circuit diagrams illustrating exemplary switching networks with respective switching configurations of the wireless power receiver arrangement 100;

FIG. 4 shows circuit diagrams illustrating exemplary switching networks with respective switching configurations of the wireless power receiver arrangement 100;

FIG. 5 shows a schematic diagram illustrating a basic model for a two-coil wireless power transfer (WPT) system 500;

FIGS. 6a, 6b show schematic diagrams illustrating a one-to-many wireless power transfer (WPT) system 600a, 600b; and

FIG. 7 shows a schematic diagram illustrating a method 700 for controlling a wireless power receiver arrangement.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

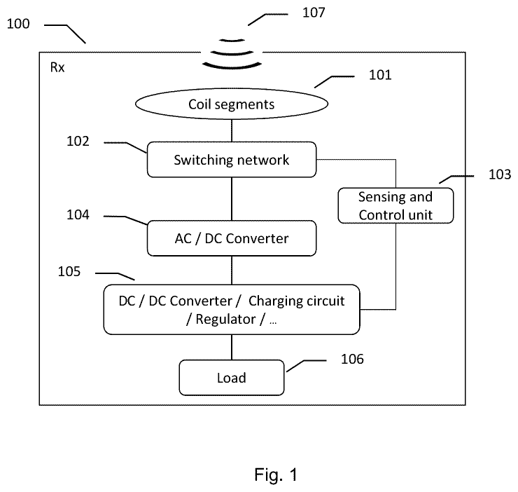

FIG. 1 shows a schematic diagram of a wireless power receiver arrangement 100 according to the disclosure. The wireless power receiver arrangement 100 can be used for receiving an electromagnetic field 107 from a wireless power transmitter (not shown in FIG. 1).

The wireless power receiver arrangement 100 comprises: a load 106; a planar inductor arrangement comprising a plurality of coil segments 101; a reconfigurable switching network 102; and a control unit 103, also referred to as sensing and control unit.

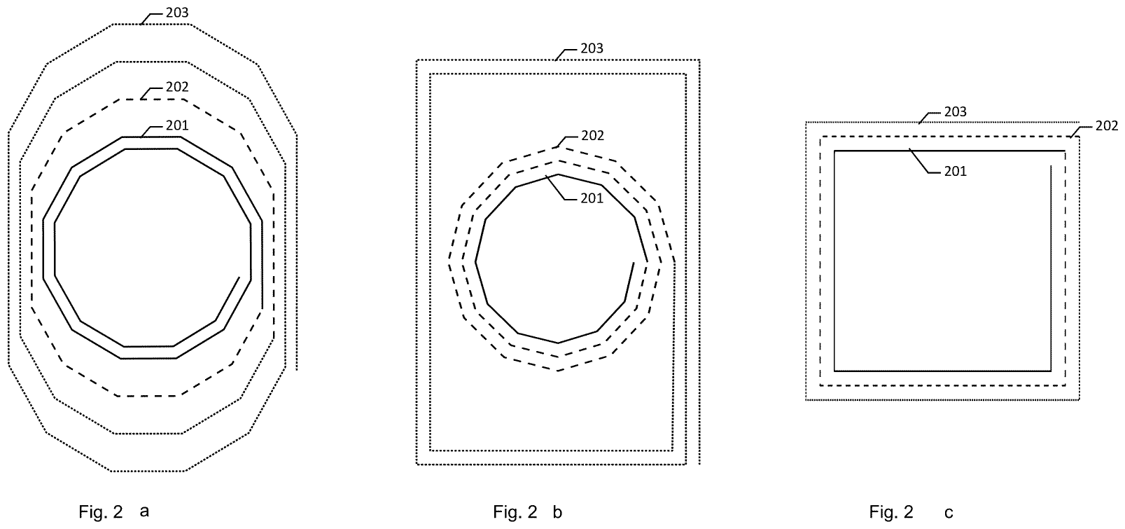

Each coil segment of the planar inductor arrangement is spanning across a respective area of a plurality of areas, e.g., as shown in FIGS. 2a, 2b, 2c, wherein the respective areas are arranged inside each other.

The reconfigurable switching network 102 is electrically coupled between coil segments of the plurality of coil segments 101, which the coil segments are spanning across the respective areas of the plurality of areas, and the load 106.

The reconfigurable switching network 102 comprises a plurality of switches which are configured to interconnect at least a coil segment from the plurality of coil segments 101 which is spanning across a smallest area of the plurality of areas, e.g., as shown in FIGS. 2a, 2b, 2c, according to a switching configuration to obtain a closed electrical circuit for powering the load 106 with electrical energy from the electromagnetic field 107.

The control unit 103 is configured to determine the switching configuration in order to reduce a variation of an electromagnetic coupling of the planar inductor arrangement to the wireless power transmitter.

The inductor arrangement is referred herein as a planar inductor arrangement. This term also comprises a flat inductor arrangement and a substantially planar inductor arrangement. It means that the term planar inductor arrangement also includes an inductor arrangement in which the coil segments are placed in different layers of a printed circuit board as described below. The PCB per se is a planar arrangement.

Note that the respective areas across which the coil segments are spanned, are consecutive areas. These areas are arranged inside each other as defined above and as shown for example in FIGS. 2a, 2b, 2c.

The control unit 103 may be configured to determine a mutual inductance of the inductor arrangement to the wireless power transmitter and to set the switching configuration in order to reduce a variation of the mutual inductance.

The respective areas of the plurality of areas may be formed by conductive layers of a multi-layer printed circuit board, for example.

In this case, the term “areas arranged inside each other” refers to projections of the areas of the different layers onto a common reference layer of the PCB, e.g., a top layer or a bottom layer of the PCB or simply the PCB plane.

The coil segments of the plurality of coil segments 101 may be placed in different layers of the multi-layer printed circuit board.

The spanning areas of each coil segment can be partially overlapping.

The flat inductor arrangement may form a receiver inductor whose physical length can be incremented or decremented to account for mutual inductance variations to the wireless power transmitter while allowing the wireless power transmitter to have a constant current level.

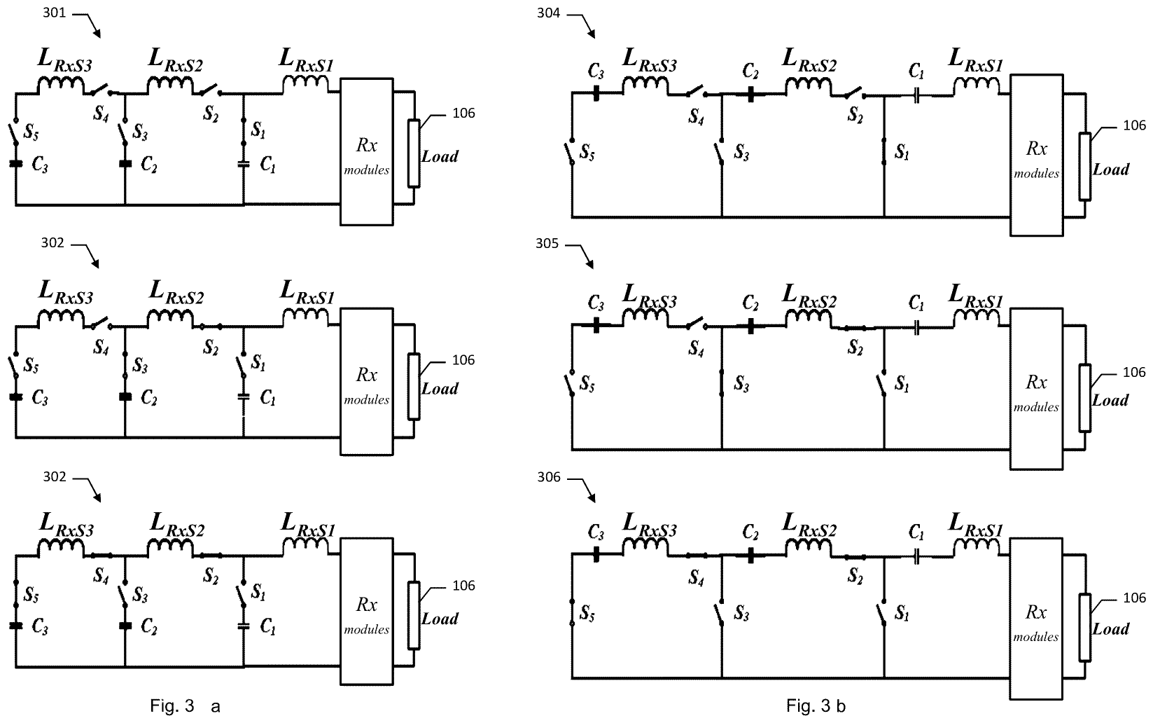

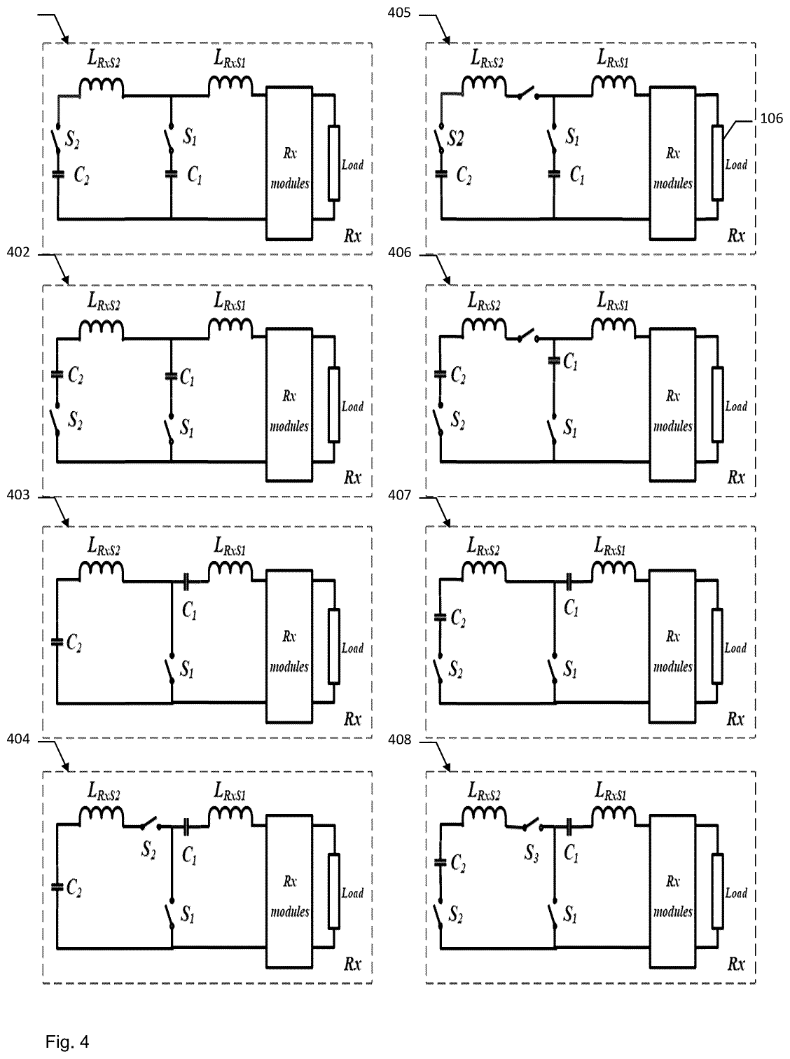

The plurality of switches of the switching network 102 can be configured to connect the coil segments 201, 202, 203, e.g., as shown in FIGS. 2a, 2b, 2c, from the plurality of coil segments 101 to at least one capacitor to create a resonant electrical circuit, e.g., as shown in FIGS. 3a, 3b and 4.

The resonant electrical circuit may be created by the plurality of switches to have the same resonance frequency as an operating frequency of the wireless power transmitter.

Alternatively, the resonance frequency of the resonant electrical circuit can be within a threshold range around the operating frequency of the wireless power transmitter.

Each coil segment 201, 202, 203, e.g., as shown in FIGS. 2a, 2b, 2c, of the plurality of coil segments 101 may comprise an integer number of turns.

Each coil segment 201, 202, 203, e.g., as shown in FIGS. 2a, 2b, 2c, of the plurality of coil segments 101 may have one of the following shapes: a circular shape, an oval shape, a meander shape, or any other polygonal shape.

The plurality of switches may comprise one or more of transistors, solid-state relays or mechanical switches automatically actuated according to the switching configuration.

The wireless power receiver arrangement 100 may comprise an AC-DC converter 104 configured to convert the electrical energy from the electromagnetic field 107 into a direct current for powering a load 106 that requires DC current.

The wireless power receiver arrangement 100 may comprise at least one of: a DC-DC converter 105 configured to convert a DC power level provided by the AC-DC converter 104 into another DC power level; or a charging circuit 105 configured to regulate the DC power provided by the AC-DC converter 104 to ensure a certain voltage level at an input of the load 106.

FIG. 1 also illustrates a block diagram of a wireless power receiver device 100 comprising a DC load 106, a substantially planar coil comprising at least two concentric coil segments 101; wherein each segment comprises an integer number of turns, an operable switching network 102 that creates a reconfigurable series electrical connection between the subsequent receiver modules, for example, and AC-DC converter 104 and a DC-DC converter 105 and the DC load 106 and at least one of the coil segments 101 to produce a closed electrical circuit for electrons to flow through when the receiver receives an electromagnetic field 107 that emanates from a wireless power transmitter; via the electromagnetic coupling K; a control unit 103, also referred to as sensing and control unit 103, to determine and set the switch configuration according to the electromagnetic coupling k to the transmitter device.

The wireless power receiver device 100 is operated to convert the received electromagnetic field into electrical energy.

The sensing and control unit 103 of the wireless power receiver device 100 can detect a change in the wireless power being received due to a change in position or orientation of the receiver device and then it sets the best switching network configuration to account for this change.

In some implementations, the receiver device 100 may include an AC-DC converter 104, for example a rectifier that converts the alternating current (AC) to a direct current (DC) if the device to be powered by the specific application requires DC, such as the case of delivering DC power to a consumer electronic device. In some other implementations, the receiver device may comprise a circuit 105 to convert a DC power level to another DC power level, such as a DC-DC converter or a charging circuit used to regulate the power delivered to the battery of the electronic device that is being supplied to or even a voltage regulator that ensures a certain voltage level at the input of the electronic device.

FIGS. 2a, 2b, 2c show schematic diagrams illustrating exemplary coil segments of the wireless power receiver arrangement 100.

These Figures show several examples of the type of receiver coil presented in this disclosure. FIG. 2a depicts an example of a substantially planar coil comprising three concentric coil segments 201, 202 and 203. Each segment comprises an integer number of turns. In this example, the first and most inner segment L_{RxS1} 201 has a circular shape and comprises two turns, the second segment L_{RxS2} 202 has an oval shape and comprises one turn and the third and most outer segment L_{RxS3} 203 has an oval shape and comprises two turns.

FIG. 2b depicts another example of a substantially planar coil comprising three concentric coil segments 201, 202 and 203. Each segment comprises an integer number of turns. In this example, the first and most inner segment L_{RxS1} 201 has a circular shape and comprises only one turn, the second segment L_{RxS2} 202 has also a circular shape but comprises two turns while the third and most outer segment L_{RxS3} 203 has a rectangular shape and comprises two turns.

FIG. 2c depicts yet another example of a substantially planar coil comprising three concentric coil segments 201, 202 and 203. Each segment L_{RxS1}, 201, L_{RxS2}, 202 and L_{RxS3}, 203 has a squared shape and comprises one single turn.

The coil segments composing the coils of FIGS. 2a, 2b, 2c can be connected to a capacitor to create a resonant circuit and to a configuration of the switching network 102 as exemplified in FIG. 3 and FIG. 4. Although, the embodiments in FIG. 2a, 2b, 2c all show coils with three coil segments, another embodiment may be represented by coils having two coil segments or coils having more than 3 coil segments.

One of the main characteristics of these coils is that the coil segments being activated by the switching network 102 are always incremental. For example, accepted operations of the coil in FIG. 2a are to have the receiver modules connected to segment 201 only or to segments 201 and 202 only, where segments 201 and 202 form a series electrical connection, or to segments 201-203, i.e., segment 202 alone cannot be connected to the receiver modules. Similarly, the coils segments being de-activated by the switching network 102 are always decremental.

The motivation behind having a receiver coil whose physical length can be incremented or decremented is to account for very large coupling factor variations to the transmitter while allowing the transmitter to function with a constant current level.

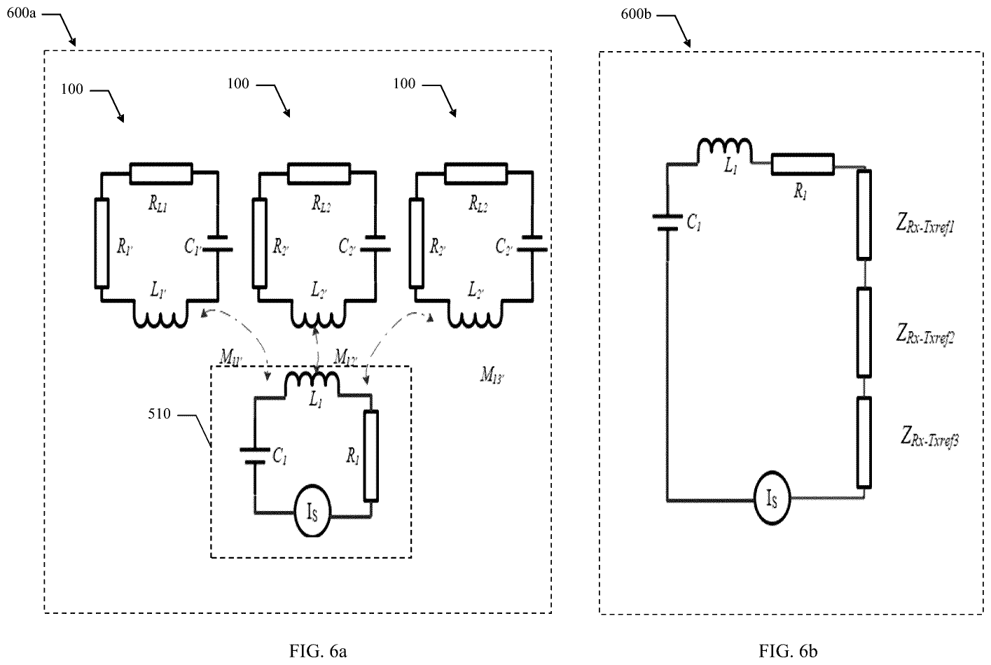

For example, the WPT systems of FIG. 6a, 6b can be loaded with receiver devices or receiver arrangements according to the present disclosure, i.e., three receiver devices or receiver arrangements 100 as described above with respect to FIG. 1. Each receiver device can have a different mutual inductance to the transmitter, for example, M_{11′}<<, M_{12′}<<M_{13′}. The current level on the transmitter device can be set so that the receiver device coupled to the transmitter with the smallest mutual inductance has a certain output power level. Instead of operating the receiver devices to connect segments 201-203 to the receiver modules, the receiver coil on the second receiver device can be configured to connect the coil segments 202 and 203 or segments 201 and 202 only while the third receiver can be operated to connect the coil segments 201 exclusively.

The incremental size of the coil of the receiver arrangements according to this disclosure allows to provide them with safe power from a constant current level of the transmitter even when their mutual inductance is not the same. On the contrary, excessive and possibly damaging power delivery to the receiver devices may happen when these are fitted with a receiver coil that does not possess the incremental feature of the coils and receiver devices disclosed herein.

The FIGS. 2a, 2b, 2c show some embodiments of the incremental coil according to this disclosure with exemplary coil geometries as well as their arrangement with respect to one another. The coil geometries may include but are not limited to square, circular, polygonal. Moreover, there can be a combination of geometries for the individual segments of the coil. The coils may include a substrate or a core material of a high permeability, magnetic or composite magnetic core. and/or a substrate with a low permeability. e.g., a dielectric substrate such as a glass-reinforced epoxy laminate or a flexible polyimide substrate.

In order for the coils to retain their shape or their arrangement with respect to one another they may be mechanically attached to a flexible carrier substrate (e.g., Thin FR4, polyimide, thin polymer, etc.). This type of planar coils can be manufactured, for instance, with printed circuit board technology or even by employing a manufacturing method that renders an increased quality factor. This can be achieved by having a substantially planar coil with a printed-circuit-board compatible substrate, e.g., by a manufacturing method as described in the following.

A method for producing a planar inductor arrangement of a wireless power receiver arrangement as described in this disclosure may comprise the following steps: providing a multi-layer substrate comprising a first conductive layer and a second conductive layer which are separated by an insulating layer; structuring the first conductive layer and the second conductive layer to form a planar inductor; removing substrate material from edges of the structured first and second conductive layers to provide a flat coil-shaped multi-layer substrate; and depositing a third and a fourth conductive layer on the insulating layer at the edges of the structured first and second conductive layers, the third and fourth conductive layers electrically connecting the structured first and second conductive layers to form a tubular conductive layer, the tubular conductive layer enclosing the flat coil-shaped multi-layer substrate.

The method may further comprise: forming the tubular conductive layer to comprise a plurality of coil segments, each coil segment spanning across a respective area of a plurality of areas; wherein the respective areas are arranged inside each other, e.g., as described in this disclosure.

Conductive materials on the top and bottom layers of the substrate can form at least two coil segments 201-202. A space without substrate material can be on the outside and inside of the turns of the coil and on the outside, inside, and in between turns. Conductive material can be deposited by electrodeposition. The electrodeposited material may electrically connect the top and bottom conducting layers forming a pipe-like conductive structure filled with the substrate material. 3D printing technology to print a conductive material can also be used.

FIGS. 3a, 3b show circuit diagrams illustrating exemplary switching networks with respective switching configurations of the wireless power receiver arrangement 100.

Two exemplary cases of an operable switching network 102, as described above with respect to FIG. 1, are depicted that creates a reconfigurable series electrical connection between the load 106, at least one of the coil segments 101 (L_{RxS1} (201), L_{RxS2} (202) and L_{RxS3} (203)), and the capacitors C₁, C₂, C₃ that together form a series electrical circuit for electrons to flow through. The coil segments 201, 202, 203 can be formed as described above with respect to FIG. 2a, 2b, 2c.

Additionally, the capacitors C₁, C₂, C₃ and sizes of the coils can be chosen so that at every valid state of the switching network 102, a very similar resonance frequency of this inductive-capacitive circuit can be maintained.

Note that this image omits the coil's and the switches parasitic resistance and capacitance for simplicity.

FIG. 3a shows three switching configurations 301, 302, 303 for the first exemplary case:

In the first switching configuration 301, switch S1 is operated to create a series electrical connection between the Rx Modules and subsequent load 106 to the first segment L_{RxS1} (201) and the capacitor C₁, while switches S2-S5 remain open.

In the second switching configuration 302, switches S2 and S3 are operated to create a series electrical connection between the Rx Modules and subsequent load 106, to the first and second segment L_{RxS1} (201) and L_{RxS2} (202) and the capacitor C₂, while switches S1, S4 and S5 remain open.

In the third switching configuration 303, switches S2, S4 and S5 are operated to create a series electrical connection between the Rx Modules and subsequent load 106, to the three coil segments 101 (L_{RxS1} (201), L_{RxS2} (202) and L_{RxS3} (203)) and the capacitor C₃, while switches S1 and S3 remain open.

Similarly, FIG. 3b shows three switching configurations 304, 305, 306 for the second exemplary case:

In the first switching configuration 304, switch S1 is operated to create a series electrical connection between the Rx Modules and subsequent load 106, the first segment L_{RxS1} (201) and the capacitor C₁, while switches S2-S5 remain open.

In the second switching configuration 305, switches S2 and S3 are operated to create a series electrical connection between the Rx Modules and subsequent load 106, the first and second segment L_{RxS1} (201) and L_{RxS2} (202) and the capacitance elements C₁ and C₂, while switches S1, S4 and S5 remain open.

In the third switching configuration 306, switches S2, S4 and S5 are operated to create a series electrical connection between the Rx Modules and subsequent load 106, the three coil segments 101 (L_{RxS1} (201), L_{RxS2} (202) and L_{RxS3} (203)) and the three capacitance elements C₁, C₂ and C₃, while switches S1 and S3 remain open.

One of the main differences between exemplary case 1 and 2 are the resultant capacitance element, which in case 2 is the result of a series connection of capacitors. Also, the electrical potential difference seen by the switches while open is different between the two cases. The switches in the switching network may comprise AC switches such as transistors back-to back, solid-state-relays or mechanical switches actuated automatically according to the information determined by the receiver sensing and control unit 103.

FIG. 4 shows circuit diagrams illustrating exemplary switching networks with respective switching configurations 401, 402, 403, 404, 405, 406, 407, 408 of the wireless power receiver arrangement 100.

FIG. 4 depicts several examples of an operable switching network 102, e.g., according to the description with respect to FIG. 1, that creates a reconfigurable series electrical connection between the Rx Modules and subsequent load 106, at least one of two coil segments 101 (L_{RxS1} (201) and L_{RxS2} (202)), e.g. formed according to FIG. 2a, 2b, 2c, and the corresponding capacitance elements C₁ and/or C₂ to produce a resonant closed electrical circuit for electrons to flow through.

This figure shows possible implementations of the receiver coils disclosed herein that have only two coil segments instead of three. Corresponding configurations 401, 402, 403, 404, 405, 406, 407, 408 can be achieved by having coils with more than three coil segments.

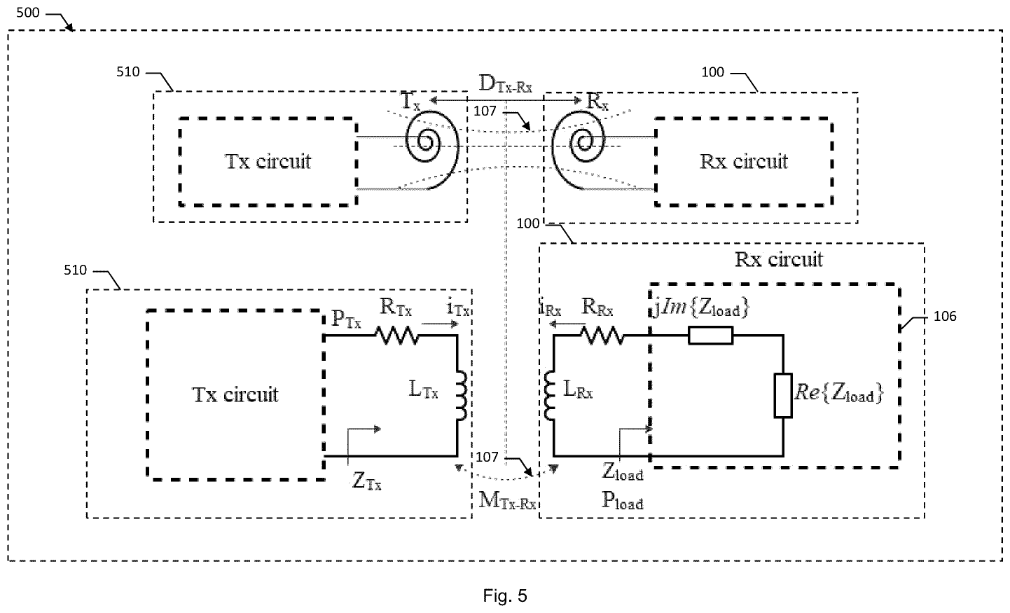

FIG. 5 shows a schematic diagram illustrating a basic model for a two-coil wireless power transfer (WPT) system 500.

Such wireless power transfer system 500 comprises: a wireless power transmitter 510 for generating an electromagnetic field 107 from a constant current source; and at least one wireless power receiver arrangement 100 as described above with respect to FIGS. 1 to 4 for receiving the electromagnetic field 107 from the wireless power transmitter 510 for powering the load 106 with electrical energy from the electromagnetic field 107.

An inductance of the flat inductor arrangement may for example be smaller for a wireless power receiver arrangement 100 located closer to the wireless power transmitter 510 than for a wireless power receiver arrangement 100 located less close to the wireless power transmitter 510.

The techniques described in this disclosure are applicable in wireless power transfer systems, in particular in systems with a single transmitter circuit and multiple receiver devices. To illustrate the usefulness of these techniques, a basic model for a 2-coil WPT system 500 is shown in FIG. 5 and serves to obtain an expression for two essential performance metrics, the wireless power link efficiency, nLink and the power delivered to the receiver circuit according to its load and coupling conditions to the receiver.

Each coil is made up of its desired characteristic, its self-inductance, as well as a few undesirable components that can be grouped into resistive and capacitive components. For the purpose of simplicity, no parasitic capacitors of the transmitter and receiver coils are considered in this model. The lumped parasitic resistances of the inductances L_{Tx} and L_{RX}, which model the losses in their windings, are R_{Tx} and R_{Rx}, respectively. The transmitter and receiver coils, separated by an arbitrary distance D_{Tx-RX} have a mutual inductance of M_{Tx-RX}, which is determined by their geometry, relative position and orientation.

The input impedance of the Rx-circuit is denoted in this figure as Z_{load}, which may be composed by a real part and an imaginary part. Z_{load} can represent, for instance, a load connected directly to the receiver resonator or it may arise from a subsequent part of the power conversion chain in the receiver device, for example from a rectifier circuit and a DC-DC converter.

When considering that the wireless power transmission between the transmitter and the receiver resonators happens in the near-field of the transmitter, there are no radiation effects included. Therefore, all the losses in the system occur due to the parasitic resistances of the transmitter and the receiver coils, R_{TX} and R_{RX}. In this manner, the power supplied by the transmitter circuit (Tx-circuit) is delivered to the receiver circuit (Rx-circuit) affected by the coils' mutual inductance and it is dissipated as heat in the equivalent series resistances of the coils.

The efficiency of the receiver coil shown in (1) can be defined as the ratio between the power delivered to the load impedance Z_{load}, denoted as P_{load} and the total power dissipated in the receiver's coil resistance R_{RX}, that is:

$${η}_{{L}_{{R}_{x}}} = \frac{Re \{ {Z}_{load} \} {i}_{Rx}^{2} / 2}{Re \{ {Z}_{load} \} {i}_{Rx}^{2} / 2 + {R}_{Rx} {i}_{Rx}^{2} / 2} \qquad ( 1 )$$

where, i_{Rx} is the peak current flowing through the loaded receiver coil and Re{Z_{load}} is the real part of the load impedance Z_{load}. Multiplying both sides of the fraction by the term ωL_{Rx}, where ω represents the frequency of operation leads to expressing the result as shown in (4), in terms of the quality factor of the receiver coil:

$${Q}_{Rx} = \frac{ω {L}_{Rx}}{{R}_{Rx}} \qquad ( 2 )$$

and the loaded quality factor of the receiver circuit:

$${Q}_{L} = \frac{ω {L}_{Rx}}{Re \{ {Z}_{load} \}} \qquad ( 3 )$$

$${η}_{{L}_{Rx}} = \frac{{Q}_{Rx}}{{Q}_{Rx} + {Q}_{L}} \qquad ( 4 )$$

The impedance seen by the transmitter, Z_{TX}, according to FIG. 5 can be calculated using Kirchhoff's laws including the effect of the mutual inductance, once can calculate this impedance as:

$$\begin{matrix}\begin{matrix}{V}_{{L}_{Tx}} = ( {R}_{Tx} + j ω {L}_{Tx} ) {i}_{Tx} + j ω {M}_{Tx - Rx} {i}_{Rx} \\ {i}_{Rx} = \frac{- {i}_{Tx} j {M}_{Tx - Rx}}{{R}_{Rx} + j ω {L}_{Rx} + {Z}_{load}}\end{matrix} \} ⇒ \\ ⟹ {Z}_{Tx} = \frac{{V}_{{L}_{Tx}}}{{i}_{Tx}} = ( {R}_{Tx} + j ω {L}_{Tx} ) + \frac{{ω}^{2} {M}_{Tx - Rx}^{2}}{{\underbrace{{R}_{Rx} + j ω {L}_{Rx} + {Z}_{load}}}_{{Z}_{Rx - {Tx}_{ref}}}}\end{matrix} \qquad ( 5 )$$

where, i_{Tx} is the peak current flowing through the transmitter circuit. It can be observed then from FIGS. 5 and (5), that the input impedance seen by the transmitter circuit, Z_{TX}, is a series combination of the R_{Tx} and L_{Tx} and a reflected impedance from the Rx-coil, Z_{Rx-Tx}_{_{ref}}, defined in (5). The Tx-coil efficiency is the power delivered to the real part of the reflected impedance, Re{Z_{Rx-Tx}_{_{ref}}}, the power transfer to the Rx coil, divided by the total power dissipated in R_{Tx} and Re{Z_{Rx-Tx}_{_{ref}}}, that is:

$${η}_{{L}_{Tx}} = \frac{Re \{ {Z}_{Rx - {Rx}_{ref}} \} {i}_{Tx}^{2} / 2}{Re \{ {Z}_{Rx - {Tx}_{ref}} \} {i}_{Tx}^{2} / 2 + {R}_{Tx} {i}_{Tx}^{2} / 2} \qquad ( 6 )$$

The maximum Tx-coil efficiency is obtained when real part of the reflected impedance is maximized, that is when the imaginary part of jωL_{Rx}+Z_{Rx-Tx}_{_{ref}} is equal to zero, which indicates that the Rx-coil is at resonance. In the case of a resonant Rx-coil, an expression for this reflected resistance can be proven to be:

$$\begin{matrix}{Z}_{Rx - {Tx}_{ref}} = \frac{{ω}^{2} {\overbrace{{k}_{Tx - Rx}^{2} {L}_{Tx} {L}_{Rx}}}^{{M}_{Tx} - {Rx}^{2}}}{{R}_{Rx} + j ω {L}_{Rx} + j Im \{ {Z}_{load} \} + Re \{ {Z}_{load} \}} ⇒ \\ ⇒ {Z}_{Rx - {Tx}_{ref}} = Re \{ {Z}_{Rx - {Tx}_{ref}} \} = {R}_{Rx - {Tx}_{ref}} = \frac{{ω}^{2} {k}_{Tx - Rx}^{2} {L}_{Tx} {L}_{Rx}}{{R}_{Rx} + Re \{ {Z}_{load} \}}\end{matrix} \qquad ( 7 )$$

Using equations (2) and (3) and defining the Tx-coil quality factor as:

$${Q}_{Tx} = \frac{ω {L}_{Tx}}{{R}_{Tx}} \qquad ( 8 )$$

the reflected resistances to the transmitter given in (7) can be rewritten in terms of those quality factors as follows:

$$\begin{matrix}Re \{ {Z}_{Rx - {Tx}_{ref}} \} = {R}_{Rx - {Tx}_{ref}} & = {k}_{Tx - Rx}^{2} {Q}_{Tx} \frac{{\overbrace{{Q}_{Rx} {Q}_{L}}}^{{Q}_{Rx - L}}}{{Q}_{L} + {Q}_{Rx}} {R}_{Tx} \\ & = {k}_{Tx - Rx}^{2} {Q}_{Tx} {Q}_{Rx - L} {R}_{Tx}\end{matrix} \qquad ( 9 )$$

where Q_{Rx-L} was defined as:

$${Q}_{Rx - L} = \frac{{Q}_{Rx} {Q}_{L}}{{Q}_{Rx} + {Q}_{L}} = \frac{ω {L}_{Rx}}{{R}_{Rx} + Re \{ {Z}_{load} \}} \qquad ( 10 )$$

Considering the reflected impedance and assuming a series resonant Rx-circuit, the resulting Tx-coil efficiency can be rewritten from (6) and (9) as:

$${η}_{{L}_{Tx}} = \frac{{Q}_{Rx - L}}{{Q}_{L}} \frac{{k}_{Tx - Rx}^{2} {Q}_{Tx} {Q}_{Rx - L}}{{k}_{Tx - Rx}^{2} {Q}_{Tx} {Q}_{Rx - L} + 1} \qquad ( 11 )$$

Finally, the total efficiency of the wireless power transfer link shown in FIG. 5 is:

$${η}_{Link} = \frac{{Q}_{Rx - L}}{{Q}_{L}} \frac{{k}_{Tx - Rx}^{2} {Q}_{Tx} {Q}_{Rx - L}}{{k}_{Tx - Rx}^{2} {Q}_{Tx} {Q}_{Rx - L} + 1} \qquad ( 12 )$$

From (12) one can immediately observe that the link efficiency increases whenever, the coupling factor between and the quality factor of the associated coils increases. The power delivered to the overall receiver circuit can be calculated from the link efficiency as:

$${P}_{Load} - {η}_{Link} {P}_{Tx} \qquad ( 13 )$$

The power at the transmitter side, P_{Tx} is dependent on the type of circuit. In general, there are four types of transmitter circuit, a voltage source and a series resonant Tx, a voltage source and a parallel resonant Tx, a current source and a series resonant Tx, and, a current source and parallel resonant Tx. From a sinusoidal voltage source with a peak value of V_{S} and a series resonant circuit at the transmitter side, i.e., 1/(C_{TX}ω)=ωL_{TX} the power delivered to the receiver circuit is:

$$\begin{matrix}{P}_{Tx} = \frac{{V}_{s}^{2} / 2}{{R}_{TX} + {R}_{Rx - {Tx}_{ref}}} \} ⇒ {P}_{Tx} = \frac{{V}_{S}^{2} / 2}{{R}_{Tx} ( {k}_{Tx - Rx}^{2} {Q}_{Tx} {Q}_{Rx - L} + 1 )} \} ⇒ \\ {P}_{Load} = {η}_{Link} {P}_{Tx} = \frac{{V}_{S}^{2}}{2 {R}_{Tx}} \frac{{Q}_{Rx - L}}{{Q}_{L}} \frac{{k}_{Tx - Rx}^{2} {Q}_{Tx} {Q}_{Rx - L}}{{( {k}_{Tx - Rx}^{2} {Q}_{Tx} {Q}_{Rx - L} + 1 )}^{2}}\end{matrix} \qquad ( 14 )$$

With a current source with a magnitude I_{S} and a series resonant Tx, the power delivered to the receiver can be found by:

$$\begin{matrix}{P}_{Tx} = \frac{{I}_{S}^{2}}{2} ( {R}_{Tx} + {R}_{Rx - {Tx}_{ref}} ) \} ⇒ \\ ⇒ {P}_{Tx} = \frac{{I}_{S}^{2}}{2} {R}_{Tx} ( {k}_{Tx - Rx}^{2} {Q}_{Tx} {Q}_{Rx - L} + 1 ) \} ⇒ \\ ⇒ {P}_{Load} = {η}_{Link} {P}_{Tx} = \frac{{I}_{S}^{2}}{2} {R}_{Tx} \frac{{Q}_{Rx - L}}{{Q}_{L}} {k}_{Tx - Rx}^{2} {Q}_{Tx} {Q}_{Rx - L}\end{matrix} \qquad ( 15 )$$

from where we can immediately observe that if the current source exciting the transmitter circuit is kept at a constant level and the receiver device got closer to the transmitter, i.e., increased its coupling factor, the power delivered to receiver also increased.

FIGS. 6a, 6b show schematic diagrams illustrating a one-to-many wireless power transfer (WPT) system 600a, 600b.

FIG. 6a, 6b show a one-to-many WPT system 600a, 600b. FIG. 6a shows the transmitter circuit 510 being excited by a current source and coupled to three independent receiver circuits 100, each one may be designed as described above with respect to FIG. 1, via the mutual inductances M_{11′}, M_{12′}, and M_{13′} each loaded with a certain load denoted as R_{L1}, R_{L2}, R_{L3}.

FIG. 6b shows a simplified version 600b of the WPT system 600a in FIG. 6a, in which the receiver circuits have been reflected back to the transmitter. This one-to-many system works with a current source with a certain amplitude I_{S}, whose value is large enough to provide usable wireless power to receivers with a reduced mutual inductance. However, this current level may be too high for receivers located close with an increased mutual inductance and even may incur damage to the receivers.

This problem can be fixed by applying an emergency shutdown on the receiver side in case the mutual inductance rises beyond a certain threshold. However, this will limit the volume in space in which the transmitter can support receivers.

In one-to-one systems this is not an issue because if the receiver is too close, the transmitter can lower the current level to not damage the Rx. In one-to-many systems, the transmitter cannot lower the current level to a safe value for the receiver device with an increased mutual inductance because it will leave the receiver device with a reduced mutual inductance without very reduced or even any wireless power delivered. However, by using wireless power receiver arrangements as described in this disclosure, such problems can be overcome due to the controlling of the switching configurations and hence inductivity of the coil configurations.

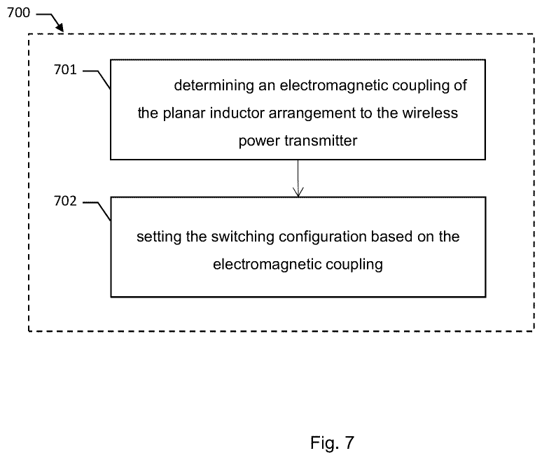

FIG. 7 shows a schematic diagram illustrating a method 700 for controlling a wireless power receiver arrangement, e.g., a wireless power receiver arrangement 100 described above with respect to FIG. 1.

The wireless power receiver arrangement 100 is controlled for receiving an electromagnetic field 107 from a wireless power transmitter. As described above with respect to FIGS. 1 to 6, the wireless power receiver arrangement 100 comprises: a load 106; a planar inductor arrangement comprising a plurality of coil segments 101, each coil segment spanning across a respective area of a plurality of areas. The respective areas are arranged inside each other. The wireless power receiver arrangement 100 comprises a reconfigurable switching network 102 electrically coupled between coil segments of the plurality of coil segments 101, the coil segments spanning across the respective areas of the plurality of areas and the load 106, e.g., as described above with respect to FIGS. 1 to 6. The reconfigurable switching network comprises a plurality of switches which are configured to interconnect at least a coil segment from the plurality of coil segments 101 which is spanning across a smallest area of the plurality of areas according to a switching configuration to obtain a closed electrical circuit for powering the load (106) with electrical energy from the electromagnetic field 107.

The method 700 comprises: determining 701 an electromagnetic coupling of the planar inductor arrangement to the wireless power transmitter.

The method 700 comprises: setting 702 the switching configuration based on the electromagnetic coupling.

The respective areas of the plurality of areas may comprise conductive layers of a multi-layer printed circuit board, for example.

The method 700 may further comprise: connecting the coil segments 201, 202, 203, e.g., as shown in FIGS. 2a, 2b, 2c, by the plurality of switches to at least one capacitor to create a resonant electrical circuit, wherein a resonance frequency of the resonant electrical circuit corresponds to an operating frequency of the wireless power transmitter.

The techniques described in this disclosure are applicable to wireless power transfer systems independent of the operating frequency or power level. For example, the output power requirements of a smartphone may differ greatly from those of a light electric vehicle.

The solutions presented in this disclosure are applicable to wireless power receiver devices like smartphones, wearables like smartwatches, fitness bands, virtual reality headsets and hand-controllers, over-ear headphones, tablets, portable computers, smart glasses, gaming controllers, desktop accessories like a mouse or keyboard, battery banks, remote controls, hand-held terminals, e-mobility devices, portable gaming consoles, portable music players, key fobs, drones used in wireless power transfer systems that allow a high-degree of freedom of the receiver.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as specifically described herein.

What is claimed is:

1. A wireless power receiver arrangement for receiving an electromagnetic field from a wireless power transmitter, the wireless power receiver arrangement comprising:
a load;
a planar inductor arrangement comprising a plurality of coil segments, each coil segment spanning across a respective area of a plurality of areas, arranged inside each other;
a reconfigurable switching network electrically coupled between coil segments of the plurality of coil segments, the coil segments spanning across the respective areas of the plurality of areas and the load, the reconfigurable switching network comprising: a plurality of switches configured to interconnect at least a coil segment from the plurality of coil segments spanning across a smallest area of the plurality of areas according to a switching configuration to obtain a closed electrical circuit for powering the load with electrical energy from the electromagnetic field; and
a controller configured to determine the switching configuration in order to reduce a variation of an electromagnetic coupling of the planar inductor arrangement to the wireless power transmitter.

2. The wireless power receiver arrangement of claim 1, wherein the controller is configured to determine a mutual inductance of the inductor arrangement to the wireless power transmitter and to set the switching configuration in order to reduce a variation of the mutual inductance.

3. The wireless power receiver arrangement of claim 1, wherein the plurality of areas are formed by conductive layers of a multi-layer printed circuit board.

4. The wireless power receiver arrangement of claim 3, wherein the coil segments are placed in different layers of the multi-layer printed circuit board.

5. The wireless power receiver arrangement of claim 1, wherein the spanning areas of each coil segment are partially overlapping.

6. The wireless power receiver arrangement of claim 1, wherein the flat inductor arrangement forms a receiver inductor whose physical length can be incremented or decremented to account for mutual inductance variations to the wireless power transmitter while allowing the wireless power transmitter to have a constant current level.

7. The wireless power receiver arrangement of claim 1, wherein the plurality of switches is configured to connect the coil segments from the plurality of coil segments to at least one capacitor to create a resonant electrical circuit.

8. The wireless power receiver arrangement of claim 7, wherein the resonant electrical circuit is created by the plurality of switches to have the same resonance frequency as an operating frequency of the wireless power transmitter, or
wherein the resonance frequency of the resonant electrical circuit lies within a threshold range around the operating frequency of the wireless power transmitter.

9. The wireless power receiver arrangement of claim 1, wherein each coil segment of the plurality of coil segments comprises an integer number of turns.

10. The wireless power receiver arrangement of claim 1, wherein each coil segment of the plurality of coil segments has one of the following shapes: a circular shape, an oval shape, a meander shape, or any other polygonal shape.

11. A wireless power transfer system, comprising:
a wireless power transmitter configured to generate an electromagnetic field from a constant current source; and
at least one wireless power receiver arrangement according to claim 1, the wireless power receiver arrangement being configured to receive the electromagnetic field from the wireless power transmitter for powering the load with electrical energy from the electromagnetic field.

12. The wireless power transfer system of claim 11, wherein an inductance of the flat inductor arrangement is smaller for a wireless power receiver arrangement located closer to the wireless power transmitter than for a wireless power receiver arrangement located less close to the wireless power transmitter.

13. A method for controlling a wireless power receiver arrangement for receiving an electromagnetic field from a wireless power transmitter, the wireless power receiver arrangement comprising a load, a planar inductor arrangement comprising a plurality of coil segments that each spans across a respective area of a plurality of areas, wherein the plurality of areas are arranged inside each other, and a reconfigurable switching network electrically coupled between coil segments of the plurality of coil segments, the coil segments spanning across the respective areas of the plurality of areas and the load, the reconfigurable switching network comprising a plurality of switches, the plurality of switches being configured to interconnect at least a coil segment from the plurality of coil segments that spans across a smallest area of the plurality of areas according to a switching configuration to obtain a closed electrical circuit for powering the load with electrical energy from the electromagnetic field, the method comprising:
determining an electromagnetic coupling of the planar inductor arrangement to the wireless power transmitter; and
setting the switching configuration based on the electromagnetic coupling.

14. The method of claim 13, wherein the respective areas of the plurality of areas comprise conductive layers of a multi-layer printed circuit board.

15. The method of claim 13, further comprising connecting the coil segments by the plurality of switches to at least one capacitor to create a resonant electrical circuit,
wherein a resonance frequency of the resonant electrical circuit corresponds to an operating frequency of the wireless power transmitter.

16. A method for producing a planar inductor arrangement of a wireless power receiver arrangement, the method comprising:
providing a multi-layer substrate comprising a first conductive layer and a second conductive layer separated by an insulating layer;
structuring the first conductive layer and the second conductive layer to form a planar inductor;
removing substrate material from edges of the structured first and second conductive layers to provide a flat coil-shaped multi-layer substrate; and
depositing a third and a fourth conductive layer on the insulating layer at the edges of the structured first and second conductive layers, the third and fourth conductive layers electrically connecting the structured first and second conductive layers to form a tubular conductive layer, the tubular conductive layer enclosing a flat coil-shaped multi-layer substrate.

17. The method of claim 16, further comprising forming the tubular conductive layer to comprise a plurality of coil segments, each coil segment spanning across a respective area of a plurality of areas, wherein the respective areas are arranged inside each other.
